(19) United States
(12) Patent Application Publication
(10) Pub. No.: US 2015/0035999 A1
(43) Pub. Date: Feb. 5, 2015

(54) METHOD FOR SHARING DIGITAL PHOTOS SECURELY

(71) Applicant: NVIDIA Corporation, Santa Clara, CA (US)

(72) Inventors: Patrick Shehane, Fremont, CA (US); Guanghua Zhang, Sunnyvale, CA (US)

(73) Assignee: NVIDIA Corporation, Santa Clara, CA (US)

(21) Appl. No.: 13/959,439

(22) Filed: Aug. 5, 2013

(51) Int. Cl. G06F 3/00; H04N 7/167; H04N 5/225

(52) U.S. Cl. CPC G06F 3/005; H04N 5/225; H04N 7/1675
USPC 348/207.1

(57) ABSTRACT

A method for sharing digital photos securely is presented. The method includes capturing image data using a digital camera system. It also includes encrypting the image data using an encryption key to produce encrypted image data. Further, it comprises storing metadata associated with the encrypting in at least one field within a file format, wherein the file format defines a structure for storing the encrypted image data, and wherein the at least one field is located within an extensible segment of the file format. Finally, it comprises transmitting the encrypted image data to a recipient.

### CROSS-REFERENCE TO RELATED APPLICATIONS

### Related Applications

The present application is related to U.S. patent application Ser. No. ______, filed ______, entitled “A METHOD FOR SHARING ORIGINAL PHOTOS ALONG WITH A FINAL PROCESSED IMAGE,” naming Patrick Shehane and Guanghua Gary Zhang as inventors, and having attorney docket number NVID-PSC-120856-US 1. That application is incorporated herein by reference in its entirety and for all purposes.

The present application is related to U.S. patent application Ser. No. ______, filed ______, entitled “A METHOD FOR CAPTURING THE MOMENT OF THE PHOTO CAPTURE,” naming Peter Mikolajczyk, Patrick Shehane and Guanghua Gary Zhang as inventors, and having attorney docket number NVID-PSC-120857-US1. That application is incorporated herein by reference in its entirety and for all purposes.

### FIELD OF THE INVENTION

Embodiments according to the present invention generally relate to sharing images and more specifically to methods for sharing images securely.

### BACKGROUND OF THE INVENTION

Image file formats are standardized means of organizing and storing digital images. Image files are composed of digital data in one of these formats that can be rasterized for use on a computer display or printer. An image file format may store data in uncompressed, compressed, or vector formats. Including certain proprietary types, there are hundreds of image file types. Some image file formats typically used to display images on the Internet are Graphics Interchange Format (GIF), Portable Network Graphics (PNG), and JPEG File Interchange Format (JFIF). Joint Photographic Experts Group (JPEG) is a popular method for compressing images circulated on the Internet, and JPEG-compressed images are usually stored in the JFIF file format or Exchangeable image file format (EXIF).

While various types of image formats are currently employed for storing and transmitting images by digital cameras and other portable electronic devices with image capturing capabilities, conventional image file formats are typically limited in the type of information that can be stored and transmitted along with the image data. In part, this limitation exists in the various standards, e.g., JFIF, EXIF, etc. in order to minimize the storage space required to store and bandwidth required to transmit the images. However, with storage becoming increasingly cheaper and broadband speeds increasing, the inability to transmit different types of associated information along with the images poses a needless and constricting limitation on the user.

Further, another limitation with conventional image capturing and storing techniques is that there are no current image file formats that support encryption. Accordingly, there is no way to encrypt and encode a conventional image format, e.g., a JFIF image before transmitting it because there are no fields within the image format that support storing encryption information. Further, there is no way to decrypt an image on the receiving end that uses the information stored within the image format for the file. Also, there is no way on conventional image displaying devices to use protected memory addresses for storing the image data to prevent the user from copying or saving the image.

### BRIEF SUMMARY OF THE INVENTION

Additionally, a need exists for systems and methods for supporting encryption of images by allowing for additional metadata fields within the image file format for storing encryption information. Further, a need exists for systems and methods for supporting decryption of images that have encryption information stored within the additional metadata fields. Finally, a need exists for systems and methods to allow for decryption and decoding to protected memory addresses for images designated as encrypted.

The recent popularity of mobile operating systems such as iOS and Android was undermined when it became evident that recipients of images could then use screen capture utilities to copy the image. Accordingly, embodiments of the present invention are advantageous because they allows for methods and systems for encoding images and storing the information required to decrypt the image within the image itself. Further, embodiments of the present invention are advantageous because they allows users to securely share pictures without risking widespread unauthorized distribution of the image. By allowing the images to be decoded to protected memory addresses, embodiments of the present invention preclude any unauthorized saving or screen capture of the image. Accordingly, users are more comfortable sharing pictures on social networking websites or via email or text with friends and family. This protects the users' privacy without sacrificing the capability and enjoyment associated with capturing and sharing images.

In one embodiment, a method for sharing digital photos securely is presented. The method includes capturing image data using a digital camera system. It also includes encrypting the image data using an encryption key to produce encrypted image data. Further, it comprises storing metadata associated with the encrypting in at least one field within a file format, wherein the file format defines a structure for storing the encrypted image data, and wherein the at least one field is located within an extensible segment of the file format. Finally, it comprises transmitting the encrypted image data to a recipient.

In another embodiment, a method for decoding an image is disclosed. The method comprises receiving image data representing an image, the image data received from a transmitter, wherein the image data comprises a file format with an extensible segment, and wherein the extensible segment comprises at least one field for storing metadata associated with an encryption of the image data. It also comprises determining if the image data is encrypted. Further, responsive to a determination that the image data is encrypted, decrypting the image data using a decryption key.

In a different embodiment, an apparatus for sharing digital images is presented. The apparatus comprises a display screen configured to display an image, a memory, a transmitter module, a digital camera system, and a processor. The process is configured to: (a) capture image data representing the image using the digital camera system; (b) encrypt the image data using an encryption key to produce encrypted image data; (c) store metadata associated with the encrypt operation in at least one field within a file format, wherein the file format defines a structure for storing the encrypted image data, and wherein the at least one field is located within an extensible segment of the file format and (d) transmit the encrypted image data to a recipient.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows an exemplary computer system 100 used to capture and/or display images in accordance with one embodiment of the present invention.

FIG. 2 shows an exemplary operating environment of a device capable of capturing and storing associated metadata in the captured images in accordance with one embodiment of the present invention.

FIG. 3 is a high level block diagram illustrating the elements of the image system proposed in accordance with an embodiment of the present invention.

FIG. 4 illustrates the modification of a JFIF segment to incorporate associated metadata in accordance with an embodiment of the present invention.

FIG. 5 illustrates the modification of a JFIF extension segment to incorporate associate metadata in accordance with an embodiment of the present invention.

FIG. 6 is a high level block diagram illustrating an exemplary method of encrypting and decrypting JPEG images using public key encryption in accordance with an embodiment of the present invention.

FIG. 7 illustrates an exemplary method of displaying images with associated metadata in accordance with an embodiment of the present invention.

FIG. 8 illustrates an exemplary method of providing options to access the metadata associated with an image on display in accordance with an embodiment of the present invention.

FIG. 9 illustrates an exemplary message displayed in response to an attempt to save an image on display in accordance with an embodiment of the present invention.

FIG. 10 depicts a flowchart of an exemplary process for encrypting images and storing associated encryption metadata in a segment of an image on an image capture device in accordance with one embodiment of the present invention.

FIG. 11 depicts a flowchart of an exemplary process of receiving and decrypting an image using associated encryption metadata in a segment of an image in accordance with one embodiment of the present invention.

FIG. 12 is a more detailed block diagram of an exemplary computer system and illustrates the various hardware and software components for storing, encrypting and decrypting images in both the camera and the software application in accordance with one embodiment of the present invention.

In the figures, elements having the same designation have the same or similar function.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Notation and Nomenclature

Some portions of the detailed descriptions that follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

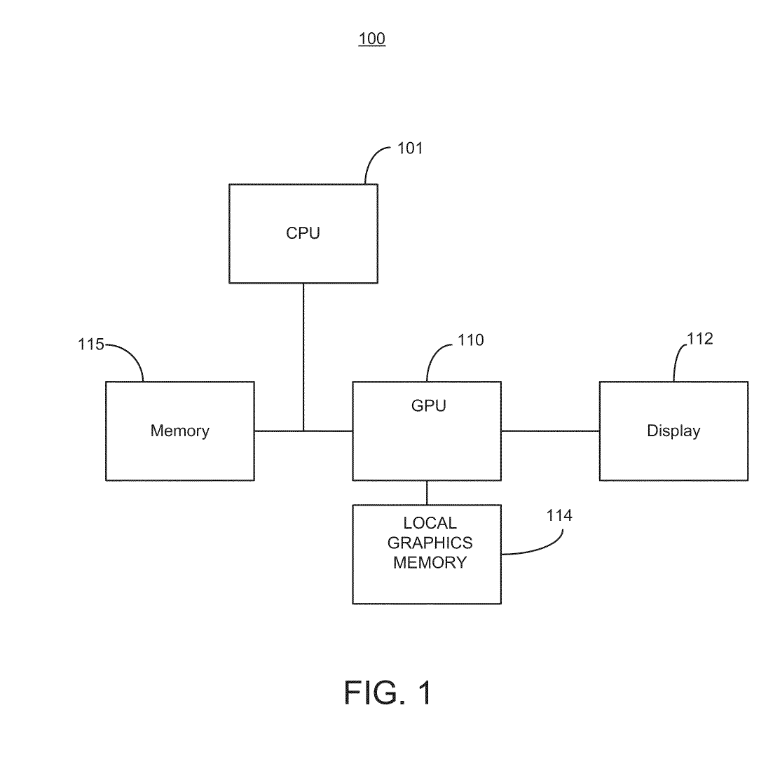

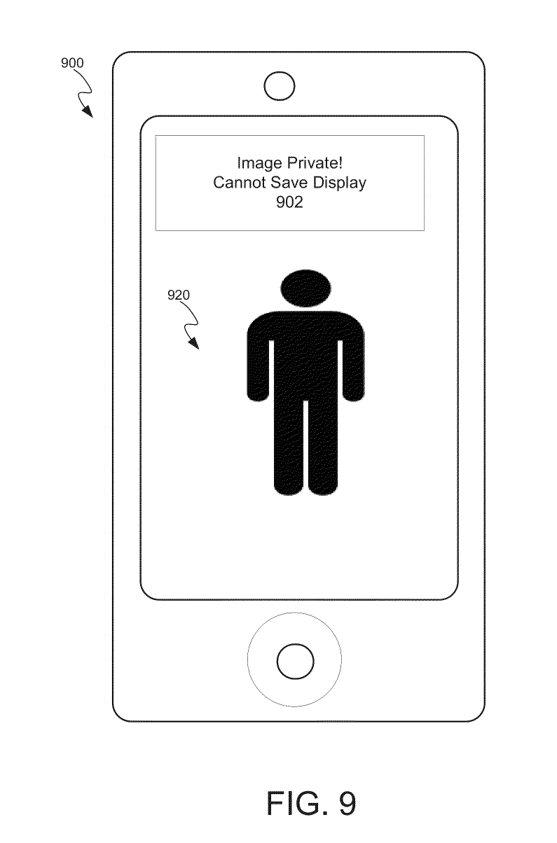

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “determining,” “encrypting,” “decrypting,” “displaying” or the like, refer to actions and processes (e.g., flowchart 900 of FIG. 9) of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 shows an exemplary computer system 100 used to encrypt or decrypt images using associated encryption metadata stored in additional metadata fields within the image format in accordance with one embodiment of the present invention. Computer system 100 depicts the components of a generic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 may be coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cell-phone, etc.), direct broadcast satellite (DBS)/terrestrial set-top box or a set-top video game console device such as, for example, the Xbox®, available from Microsoft Corporation of Redmond, Wash., or the PlayStation 3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

A Method for Sharing Digital Photos Securely

Most conventional image formats in commercial use today constrict the scope of what a user can do with a captured image. More specifically, conventional image formats do not have the flexibility to allow images to be encrypted or to include encryption information, for example, by providing for designated segments within the file format of the image to store associated encryption metadata that can be accessed to decode the image. Further, conventional image display systems do not have the hardware or software support necessary to encrypt or decrypt images, nor do they have any means to allow encrypted image data to be stored in protected memory addresses.

Accordingly, embodiments of the present invention provide for systems and methods for protecting a user's privacy when storing or sharing digital images by allowing the users to encode encryption information within certain designated segments of the corresponding image file format. Further, embodiments of the present invention provide for systems and methods for decrypting images that have been encrypted using the encryption metadata stored within the image. Finally, embodiments of the present invention provide for systems and methods for decrypting and decoding the encrypted image streams to protected memory addresses so that the image data cannot be copied. Accordingly, the present invention is advantageous because it allows users to securely share pictures without risking widespread unauthorized distribution of the image.

Further, in one embodiment of the present invention, a dynamic, non-standard image file format is provided that contains fields allocated for storing various types of associated information or metadata related to the image data, e.g., encryption information. In a different embodiment, the present invention provides a method for modifying standardized image formats, e.g., the JFIF image format to allow additional related metadata, e.g., encryption information to be included in designated fields within the image.

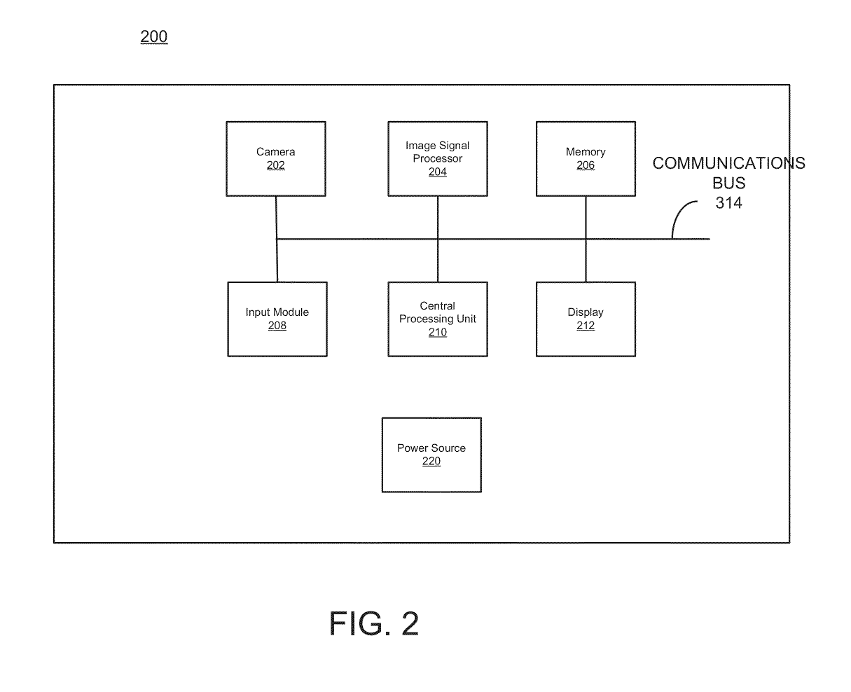

FIG. 2 shows an exemplary operating environment of an image access device capable of encrypting or decrypting image data using stored metadata in the captured images in accordance with one embodiment of the present invention. System 200 includes camera 202, image signal processor (ISP) 204, memory 206, input module 208, central processing unit (CPU) 210, display 212, communications bus 214, and power source 220. Power source 220 provides power to system 200 and may be a DC or AC power source. System 200 depicts the components of an exemplary system in accordance with embodiments of the present invention providing the execution platform for certain hardware-based and software-based functionality. Although specific components are disclosed in system 200, it should be appreciated that such components are examples. That is, embodiments of the present invention are well suited to having various other components or variations of the components recited in system 200. It is appreciated that the components in system 200 may operate with other components other than those presented, and that not all of the components of system 200 may be required to achieve the goals of system 200.

CPU 210 and the ISP 204 can also be integrated into a single integrated circuit die and CPU 210 and ISP 204 may share various resources, such as instruction logic, buffers, functional units and so on, or separate resources may be provided for image processing and general-purpose operations. System 200 can be implemented as, for example, a digital camera, cell phone camera, portable device (e.g., audio device, entertainment device, handheld device), webcam, video device (e.g., camcorder) or any other device with a front or back facing camera that allows the device to detect the presence of a user.

In one embodiment, camera 202 captures light via a front-facing or back-facing lens (depending on how the user typically holds the device), and converts the light received into a signal (e.g., digital or analog). In another embodiment, system 200 may also have another camera facing away from the user (not shown). Camera 202 may comprise any of a variety of optical sensors including, but not limited to, complementary metal-oxide-semiconductor (CMOS) or charge-coupled device (CCD) sensors. Camera 202 is coupled to communications bus 214 and may provide image data received over communications bus 214. Camera 202 may comprise functionality to determine and configure optical properties and settings including, but not limited to, focus, exposure, color or white balance, and areas of interest (e.g., via a focus motor, aperture control, etc.).

In one embodiment, camera 202 in FIG. 2 represents two cameras, one with a lower resolution than the other camera, as disclosed in co-pending applications, U.S. patent application Ser. No. 13/609,019, titled “System and Method for Enhanced Monoimaging” filed on Sep. 10, 2012, and U.S. patent application Ser. No. 13/609,062, titled “System and Method For Enhanced Stereo Imaging,” filed on Sep. 10, 2012, both of which are incorporated herein by reference in their entirety and for all purposes.

Image signal processor (ISP) 204 is coupled to communications bus 214 and processes the signal generated by camera 204, as described herein. More specifically, image signal processor 204 may process data from camera 202 for storing in memory 206. For example, image signal processor 204 may compress and determine a file format for an image to be stored in within memory 206. Further, by of example, image signal processor may be configured to add metadata related to the image within the file format for the image as well. Alternatively, CPU 210 could also be configured to populate the designated segments within the file format of the image with the related metadata, e.g., audio clips related to the image.

Input module 208 allows entry of commands into system 200 which may then, among other things, control the sampling of data by camera 202 and subsequent processing by ISP 204. Input module 208 may include, but it not limited to, navigation pads, keyboards (e.g., QWERTY), up/down buttons, touch screen controls (e.g., via display 212) and the like.

Central processing unit (CPU) 210 receives commands via input module 208 and may control a variety of operations including, but not limited to, sampling and configuration of camera 202, processing by ISP 204, and management (e.g., addition, transfer, and removal) of images and/or video from memory 206.

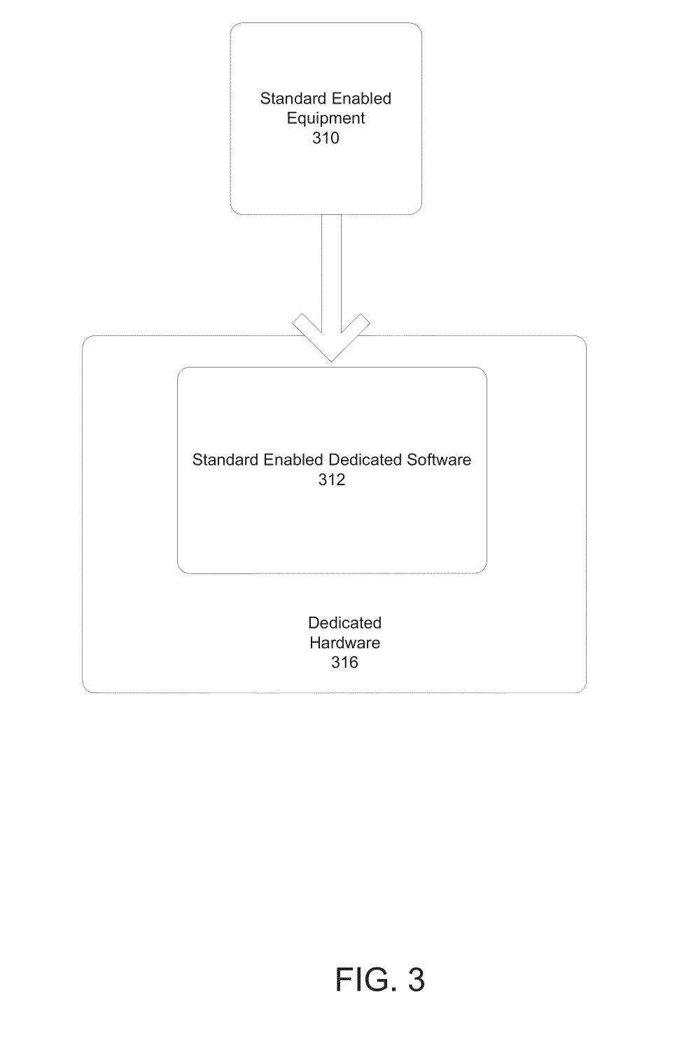

FIG. 3 is a high level block diagram illustrating the elements of the image system proposed in accordance with an embodiment of the present invention. In one embodiment of the present invention, standard enabled equipment 310 is capable of capturing and storing images with associated encryption metadata in designated segments of the image file format. A basic condition of the equipment 310 with a playback function is that it be able to write and read the files with the associated encryption metadata. In one embodiment, standard enabled equipment 310 performs a similar function to system 200 in FIG. 2.

The protocol used for storing images by equipment 310 can be a modified variation to an existing standard, e.g., JFIF that has been altered to accommodate additional metadata fields. Alternatively, in one embodiment, the equipment 310 can store images in accordance with a new standard that has designated fields for embedding associated metadata, e.g., encryption information, audio clips, related image information, etc. The standard enabled equipment 310 can be an imaging device such as a camera, or a portable electronic device such as a phone, tablet, etc. with a camera that is capable of capturing images.

The standard enabled equipment 310 can, in one embodiment, communicate with a standard enabled dedicated software 312 that is operable to receive, encrypt and/or decrypt the images and associated metadata from the equipment 310. In the personal computer environment, for example, the requirement would be that the dedicated software 312 be able to read, encrypt and decrypt all the images from equipment 310 including all the associated metadata and attribute information in conformance with the modified or new file format standard. In one embodiment, the dedicated software 312 is a type of commercial software that is widely available commercially or provided by the manufacturer of equipment 310. In one embodiment, the dedicated software 312 can be configured to allow the user to view the image while presenting the option to view or access the associated metadata stored in a designated field within the image. In one embodiment, the dedicated software 312 is installed on dedicated hardware 316 that is configured to encrypt the image and generate an encoded bit-stream. In one embodiment, dedicated hardware 316 is also configured to decode an encoded image bit-stream and store the bit-stream in protected memory addresses before rendering the image on screen. For example, using protected virtual address mode or virtual protective ring (VPR) technology, hardware 316 can be configured to manipulate the memory address so the real memory address is not available for memory content copy.

There are several possible ways to define a new standard for an image file format that designates segments for the storage of associated metadata in accordance with embodiments of the present invention.

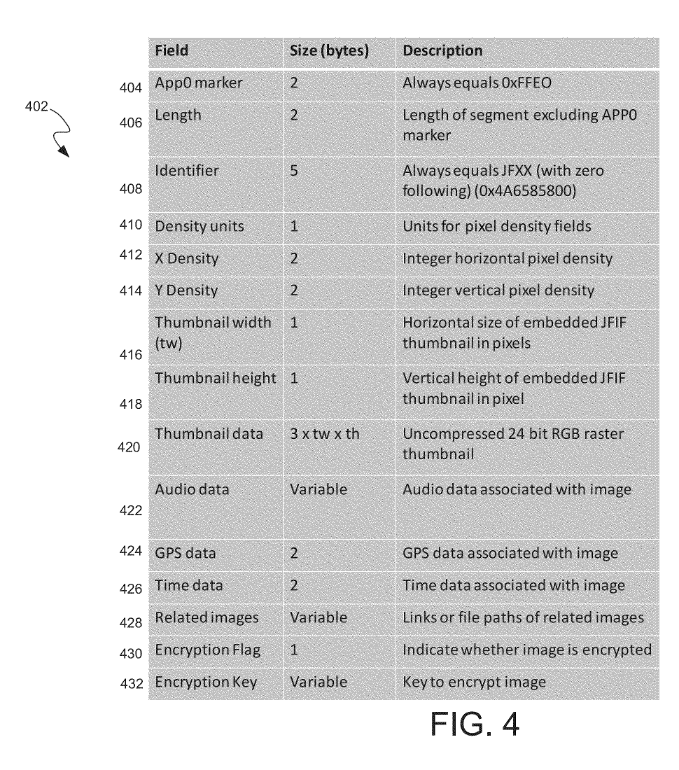

Similarly, there are several techniques for modifying existing file formats to support storage of associated metadata. One such file format, as discussed above, is JFIF. JFIF is designed to allow files containing JPEG-encoded streams to be exchanged between otherwise incompatible systems and applications. FIG. 4 illustrates the modification of a JFIF segment 402 to incorporate associated metadata in accordance with an embodiment of the present invention.

A valid JFIF file must typically start with a two-byte start-of-image (SOI) marker (not shown) which is 0xFFD8. This is followed by a JFIF APP0 (Application) marker 404, which consists of the marker code values 0xFFEO and the characters “JFIF” in the marker data. Although JFIF files do not possess a formally-defined header, the SOI and JFIF APP0 markers taken together act as a header in the marker segment structure 402 illustrated in FIG. 4. The length field 406 is the size of the JFIF marker segment 402, including the size of the length field 406 itself and any thumbnail or other data contained in the APP0 segment.

The other fields that are conventionally present in a JFIF (APP0) marker segment are as follows: a) an identifier field 408 used to identify the code stream as conforming to the JFIF specification; b) a density units field 410 to identify units for pixel density fields; c) an X Density field 412 and a Y Density field 414 to identify the unit of measurement used to describe the image resolution; d) a thumbnail width 416 to define the horizontal size of embedded JFIF thumbnail; e) a thumbnail height 418 to define the height of an embedded JFIF thumbnail; and f) thumbnail data 420 comprising the image data for the thumbnail.

In addition to the conventional fields defined in the JFIF (APP0) marker segment, in one embodiment of the present invention, the JFIF (APP0) marker segments can be extended to incorporate additional fields, e.g., fields 422, 424, 426, 428 and 430 in FIG. 4, in order to provide the flexibility and convenience to embed metadata associated with the image. For example, an audio data field 422 can be added to the marker segment that embeds a short encoded audio clip related to the image within the image itself. Embedding an encoded audio clip in the image file itself is advantageous, because while in some cases an image by itself can be sufficient, in most cases users may want to record other sensory input contemporaneous with the taking of the image. For example, if the user is proposing to a significant other, it would be highly desirable to be able to capture a few seconds of audio right before and after the capturing of the image in order to record the buildup to the moment including the reaction to the proposal.

While most cameras can record video, simply capturing a video of the occasion does not provide the desired functionality and flexibility because videos in most cases are much lower quality than an audio image. Also, typically a single representative image of an event like a wedding proposal, a goal in a soccer game, or a student's graduation can be much more memorable than a video clip. In addition, finding a single representative image from a video clip comprising 30 to 40 seconds of footage, for example, is more challenging that simply capturing a single image when the timing is right. Further, in certain cases the user may just want a still image of the occasion while having the flexibility to listen to a brief audio clip related to the image.

In one embodiment, the recording of the audio clip is activated when the user initiates the focusing process so as to capture a few seconds of audio before the actual image is captured. In another embodiment, the audio clip can start recording when the user actuates the image capture trigger.

In other embodiments, a separate pushbutton can be provided to activate the audio recording, so that the audio capture process is not tied to image capture. The user can then be presented an option to choose the image that the audio clip should be associated with. The equipment 310 can then encode the audio clip and embed it in the designated segment of the file format for the user specified image.

In one embodiment, the user is provided with the flexibility to control the length of the audio clip. The user may do this using a user interface on equipment 310 or software 312 that allows the user to control options related to the captured images. In accordance with this flexibility, the size of field 422 in the JFIF (APP0) marker segment is variable.

In one embodiment, the present invention allows GPS data 424 to also be embedded in, for example, the marker segment of the JFIF file as shown in FIG. 4. This GPS metadata field can be used for various purposes by equipment 310 and dedicated software 312, including, for example, to group related images. As will be explained further below, in one embodiment, the GPS field can be encrypted for privacy reasons so that it can be accessed by equipment 310 and software 312 to identify and group related images, but may not be accessed for viewing in a publicly readable format or for any other purpose. In one embodiment, the GPS field can be used to organize and group pictures automatically as they are captured by equipment 310.

In one embodiment, the present invention allows time data 426 to also be embedded in, for example, the marker segment of the JFIF file as shown in FIG. 4. While conventional image formats may allow the time of image capture to be saved with the image file, the present invention allows the time to be embedded in a dedicated field that can then be used to search for and identify related images taken within a certain time duration. Further, in one embodiment, the present invention may allow the user to have control over the time data field 426 and be able to manually adjust it if needed either using equipment 310 or software 312. Also, in one embodiment, the time field may be encrypted for privacy reasons.

In one embodiment, the present invention allows related image data 428 to be embedded in, for example, the marker segment of the JFIF file as shown in FIG. 4. The related images field 428 can, in one embodiment, be variable. Related image data can be stored in any number of various ways. For example, in one embodiment, links or pointers to all the various related images can be stored within this field. In a different embodiment, field 428 can comprise a file path for all related images. In yet another embodiment, field 428 can comprise a thumbnail of all related images. It may even comprise one or more short related movies regarding the image.

The criteria for what constitutes a related image may be ascertained by the user and entered through a user interface into the image capture settings available in equipment 310 or software 312. Exemplary criteria that can be used to identify related images are time of image, GPS location data in image, file name, file path, user annotation in field 430 (discussed in more detail below), etc. For example, a user may choose to identify all images taken on his or her birthday as a related image. In this case, time field 426 may be used to identify the relevant images. Subsequently, links would be added to the related images field 428 to images taken on the user's birthday that can be accessed by the equipment 310 or software 312. In one embodiment, if the storage space on equipment 310 is limited, then the software 312 can be configured to perform another search to identify further related images after the images are downloaded from equipment 310 to software 312.

In one embodiment, a voice speech search procedure may be employed on the audio data 422 field of the images to identify related images. For example, the voice speech search could be used to search all images where the “Happy Birthday” song is sung. Once the related images have been identified, information regarding these images is subsequently added in field 428.

In one embodiment, related images can be images captured immediately preceding or following the moment of shutter press. When capturing a photo of a moment, either of family, friends, or a scene, several images preceding and proceeding the time of shutter press can be captured, encoded and saved in field 428 so that a later playback can provide more than just a static representation of that moment in time. In one embodiment, a short movie capture could be saved as well in the related images field 428.

Co-pending applications, U.S. patent application Ser. No. 13/609,019, titled “System and Method for Enhanced Monoimaging” filed on Sep. 10, 2012, and U.S. patent application Ser. No. 13/609,062, titled “System and Method For Enhanced Stereo Imaging,” filed on Sep. 10, 2012, discloses a system comprising two cameras wherein, in one embodiment, the pictures using the two cameras may be captured substantially simultaneously. In one embodiment of the present invention, each of the images captured by the respective camera could comprise an embedded link or thumbnail of the image captured by the other camera.

Similarly, in one embodiment, for devices that comprise both a front facing and back facing camera, images could be captured by both cameras substantially simultaneously. Further, associated metadata could be stored in field 428 of each image comprising information regarding the image captured by the other camera on the same device. Further, a first image taken from the front facing camera could be authenticated using information from a second image taken using the back facing camera and stored within field 428 of the first image. For example, the second image taken by the back facing camera may be a picture of the individual taking the photograph. This image could then be used to authenticate and verify the first image, wherein the second image is encoded within a segment of the first image.

Certain conventional devices also have the ability to capture several pictures consecutively after shutter press, wherein the multiple pictures are used to adjust undesirable visual affects such as poor lighting or jitter. In one embodiment, each of these captured images will embed links, thumbnails or other identifying information for the images that are captured during the same brief segment of time following shutter press.

In one embodiment, the present invention allows an encryption flag 430 to be embedded in, for example, the marker segment of the JFIF file as shown in FIG. 4. In one embodiment, this field can be used to indicate to a receiving device that the image is encrypted.

In another embodiment, this field can be user specified and used to indicate whether an image should be encrypted by either, for example, the standard enabled equipment 310 or dedicated hardware 316. Subsequently, the encrypted image can only be viewed by a user or device possessing the necessary key to decrypt the information.

In one embodiment, the present invention allows an encryption key 432 to be embedded in, for example, the marker segment of the JFIF file as shown in FIG. 4. For example, in one embodiment, standard enabled equipment 310 could encrypt a document with a symmetric key, and then encrypt the symmetric key with the public key of the receiving computer. The symmetric key could be stored in field 432 of the captured image. The receiving computer would then use its private key to decode the symmetric key stored in field 432 and, subsequently, use the decoded symmetric key to decode the document. In other embodiments, it may not be necessary to store encryption key 432 within the image and the image could be transmitted securely using a different kind of encryption.

In one embodiment, dedicated software 312 or even equipment 310 can be configured to have slideshow capabilities, and further configured to display images in the slideshow in a way such that the associated audio clip either from the audio data field 422 or from the other field 430 for an image is played in full while displaying the image and before transitioning to the next image. The user may, in one embodiment, be able to choose the field (e.g., 422 or 430) that the audio clips should be accessed from while viewing the slideshow. Further, the slideshow capabilities may be configured to also display the related images identified in field 428 when displaying an image to the extent any are specified.

In one embodiment, instead of encrypting the entire image, the associated metadata fields, e.g., fields 422, 424, 426, and 428 may be encrypted and can only be accessed by a user or device possessing the necessary key to decrypt the information. For example, in certain instance, while the user may want the flexibility of preserving GPS data in an image for personal reasons, the user may not desire to have the GPS metadata published if the image is shared through email or via a social networking site. In such cases, it is beneficial to have the option to encrypt the metadata fields so the user has control over the sharing of the associated metadata fields. In one embodiment, certain associated metadata fields, e.g., time and GPS data, can be encrypted and hidden from everyone including the user, and only used by standard enabled equipment 310 and dedicated software 312 for sorting and organizational purposes and to identify related images. In one embodiment, the user may be able to choose through a user interface whether or not the associated metadata fields should be encrypted.

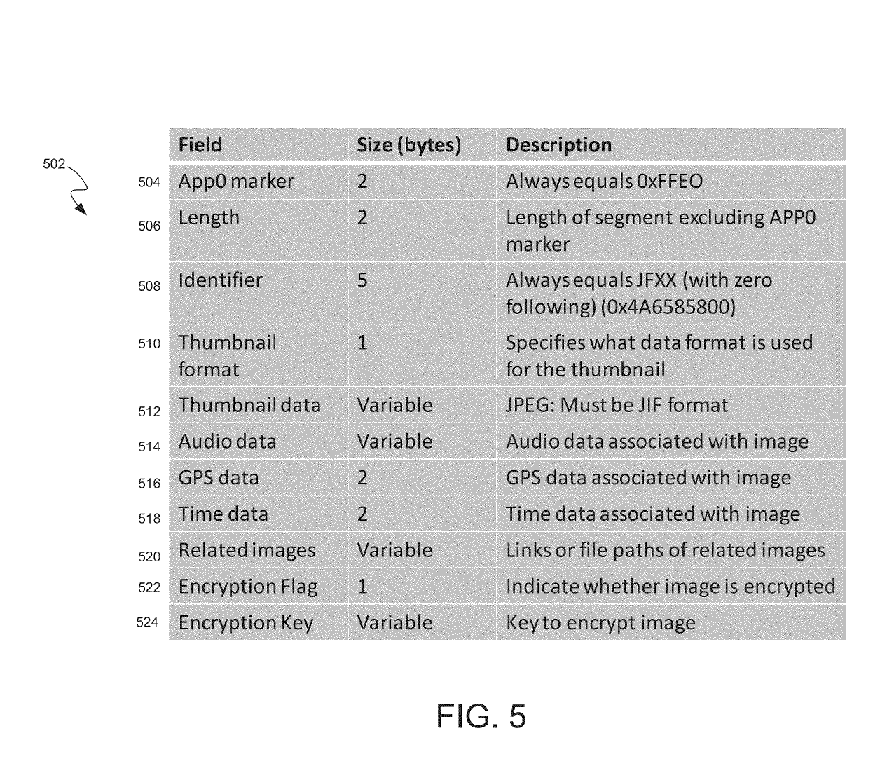

In a typical JFIF image, following the JFIF marker segment, there may be one or more optional JFIF extension marker segments. Extension segments are used to store additional information. FIG. 5 illustrates the modification of a JFIF extension segment to incorporate associate metadata in accordance with an embodiment of the present invention.

Similar to FIG. 4, certain fields shown in FIG. 5 are also found in a conventional JFIF extension marker segment. For example, a typical JFIF extension marker segment will comprise the APP0 marker 504 with the value 0xFFEO, a length field 506, an identifier 508, a thumbnail format 510, and thumbnail data 512.

In accordance with an embodiment of the present invention, the JFIF extension marker segment can be modified to include additional fields such as the audio data field 514, the GPS data field 516, the time data field 518, the related images field 520, encryption flag 522 and encryption key 524. Fields 514, 516, 518, 520, 522 and 524 work in substantially the same way as the corresponding fields in FIG. 4.

It is worth noting that while the present invention has been discussed in the context of the JFIF image file format, the novel aspects and techniques of the invention can be used with any number of various different file formats as well. For example, the Exchangeable image file format (EXIF) is a standard that specifies the formats for images used by digital cameras and scanners also. One of the fields that the EXIF standard defines in its specification is a “Makernote” field which typically has a storage capacity of between 0 and 64 kilobytes. The EXIF standard defines a MakerNote tag, which allows camera manufacturers to place custom format metadata in the file typically related to the digital camera settings, e.g., shooting modes, focusing modes, etc. The present invention can also be applied to extending the Markernote field of the EXIF standard to include the additional metadata discussed above, e.g., audio data, related image information, GPS data, time data, encryption information etc.

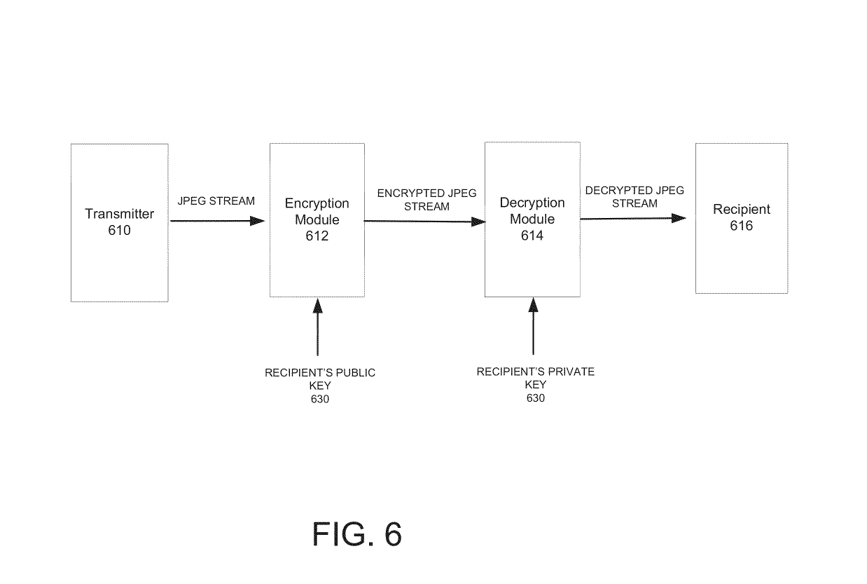

FIG. 6 is a high level block diagram illustrating an exemplary method of encrypting and decrypting JPEG images using public key encryption in accordance with an embodiment of the present invention. It should be noted that public key encryption is simply one option for encrypting an image that may be used by equipment 310 or by hardware 316. Several other procedures for encrypting images may also be employed.

In one embodiment, transmitting device 610, which may be either standard enable equipment 310 or dedicated hardware 316, sends the JPEG image stream to an encryption module 612 after it has been captured to encrypt the image. Encryption module can set the encryption flag 430 in the image and may also encode a symmetric key that may be used to encrypt the image into field 432 of the image. Recipient's public key 630 may then be used to encrypt the symmetric key stored in field 432. The image is then transmitted to a receiver, which comprises decryption module 614. Decryption module may test the image to determine if encryption flag 430 is set. If encryption flag 430 is set, then decryption module 614 uses the recipient's private key 630 to decrypt the symmetric key stored in field 432. Once the symmetric key has been extracted, it can be used to decrypt the image by module 614. The image data can thereafter be stored by recipient 616 in a protected memory address. The image data in the protected memory address can be rendered on screen, but cannot be saved, shared on a social networking site or via email or text, or captured via a screen capture operation.

In one embodiment, the encrypting may be performed in accordance with a public key cryptographic procedure, wherein the public key cryptographic procedure may be selected from a group comprising public key distribution system, shared secrets, digital signature system and public key cryptosystem. Alternatively, the encrypting may be performed in accordance with a cryptographic certificate system wherein the cryptographic certificate system uses a secure certificate system selected from a group comprising X.509, RSA, ECC, and Diffie-Helman or other cryptographic certificate signature/verification procedure mutually agreed upon by the transmitter and receiver.

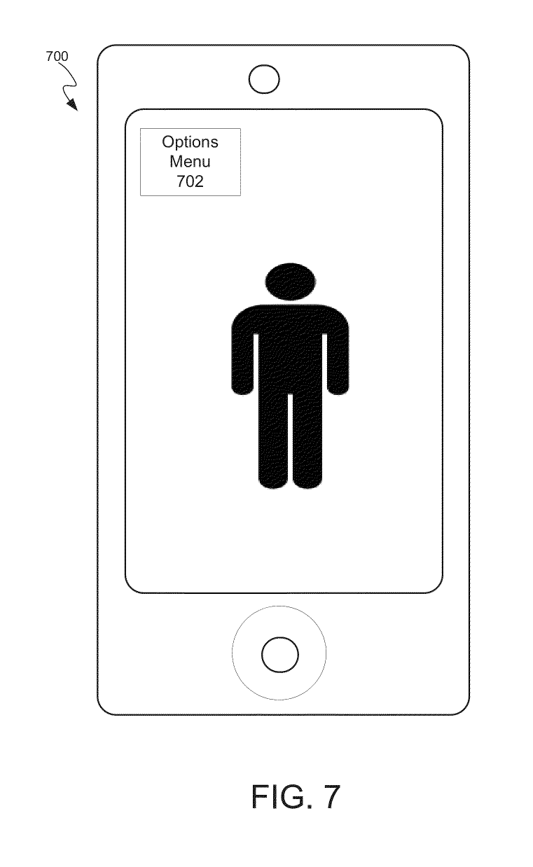

FIG. 7 illustrates an exemplary method of displaying images with associated metadata in accordance with an embodiment of the present invention. In order to display images and the associated embedded metadata, device 700 should be configured so that it can read the images including all the associated metadata and attribute information in conformance with the modified or new file format standard taught by the present invention. Device 700 can either be an example of standard enable equipment 310, or it could be an example of dedicated hardware 316 with the standard enabled dedicated software 312 installed onto it. Traditional devices that do not have the dedicated software to display the associated metadata will simply display the image in the conventional way without allowing the user the option to access the embedded fields.

As shown in FIG. 7, when an image with associated metadata is displayed on the screen of device 700, an icon 702 can appear on the screen alerting the user that additional data associated with the image is available for access.

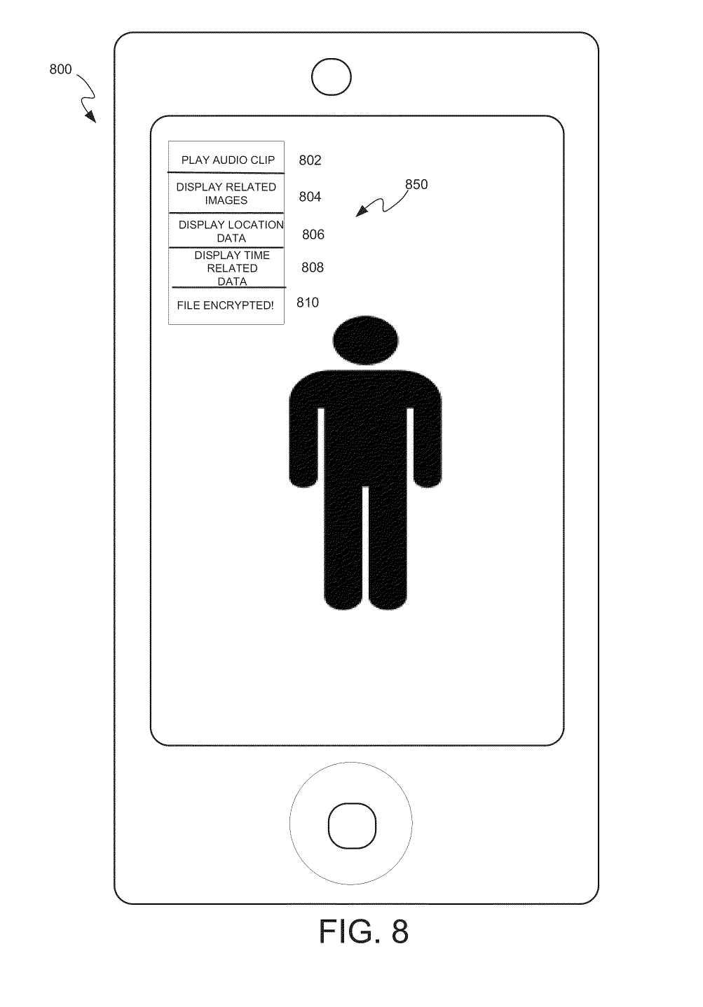

When the user clicks on the options icon 702 appearing on screen, a drop down menu of options becomes available to the user in accordance with one embodiment of the present invention. FIG. 8 illustrates an exemplary method of providing options to access the metadata associated with an image on display in accordance with an embodiment of the present invention.

The drop down menu 850 allows the user to play the associated audio clip 802, display related images 804, display location data 806, and display time related data 808. The drop down menu may also have an indication 810 to convey if the file is encrypted based on the status of encryption flag 430. Each of the options displays or plays the associated metadata by accessing the corresponding field shown in FIG. 4.

FIG. 9 illustrates an exemplary message displayed in response to an attempt to save an encrypted image on display in accordance with an embodiment of the present invention. If device 900 receives the decrypts image 920 and stores the image data in protected memory address using protected virtual address mode, then device 900 will be unable to save the image data or capture it using screen capture because the real memory address will be unavailable for memory content copy. In this case, a message 902 will be displayed on screen informing a user that the image cannot be saved.

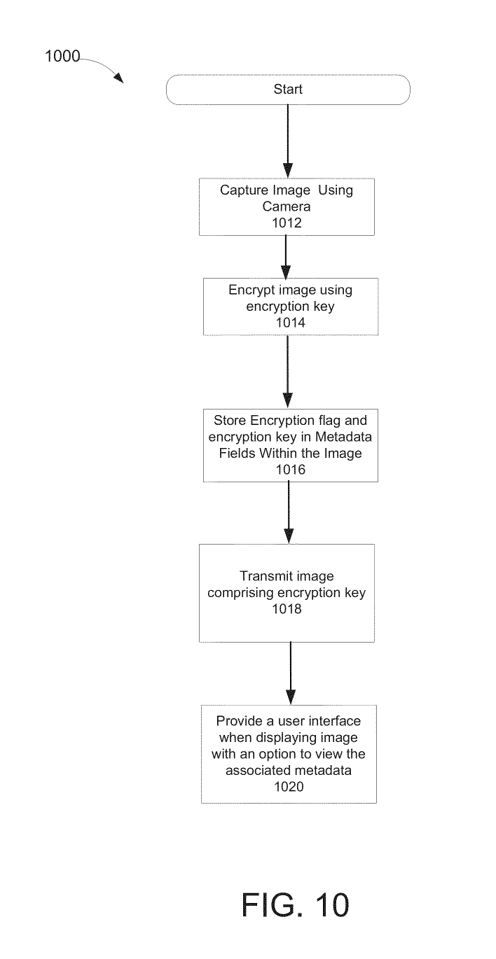

FIG. 10 depicts a flowchart of an exemplary process for encrypting images and storing associated encryption metadata in a segment of an image on an image capture device in accordance with one embodiment of the present invention.

At step 1012, an image is captured with a camera, which functions substantially similarly to standard enabled equipment 310 and device 700.

At step 1014, responsive to a user setting that an image should be encrypted, the image is encrypted using an encryption key.

At step 1016, the encrypted image is stored with the encryption flag 430 set and the encryption key stored in metadata field 432 as discussed in connection with FIGS. 4 and 6.

At step 1018, the image with encryption information stored in additional metadata fields is transmitted.

Optionally, at step 1020, the camera recognizes the image as having a specialized file format with associated metadata fields and displays the captured image with a user interface that provides the user with an option to access the associated metadata, e.g., metadata showing. One example of this interface is provided in FIG. 8 in the form of a menu of available options 850.

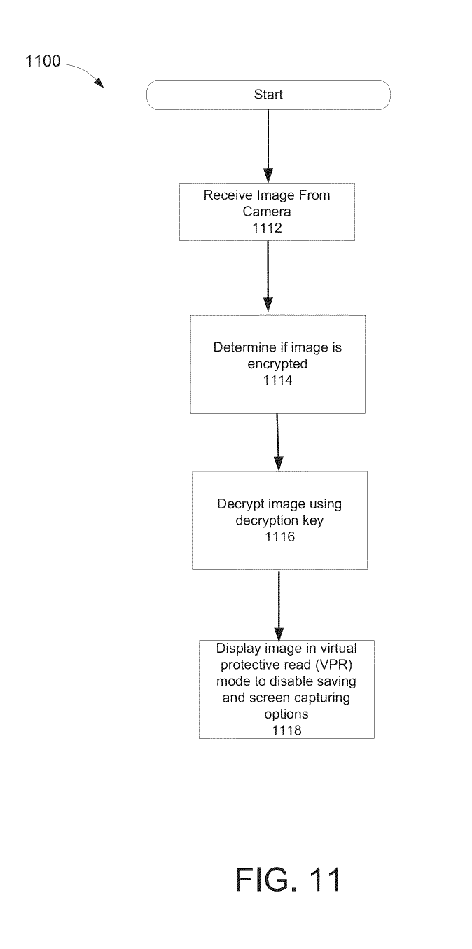

FIG. 11 depicts a flowchart of an exemplary process of receiving and decrypting an image using associated encryption metadata in a segment of an image in accordance with one embodiment of the present invention.

At step 1112, a personal computer or any type of portable computing device receives the captured image transmitted from the transmitting device.

At step 1114, the receiving device determines if the image is encrypted using the encryption flag 430.

At step 1116, the receiving device can decrypt the image using a decryption key. As discussed above in connection with FIG. 6, in one embodiment this decryption key may be the receiver's private key.

At step 1118, the image can be displayed on the receiving device screen in protected virtual address mode or virtual protective ring (VPR) mode. This mode ensures that the real memory address will be unavailable for memory content copy, which prohibits the user from being able to save or perform a screen capture of the image.

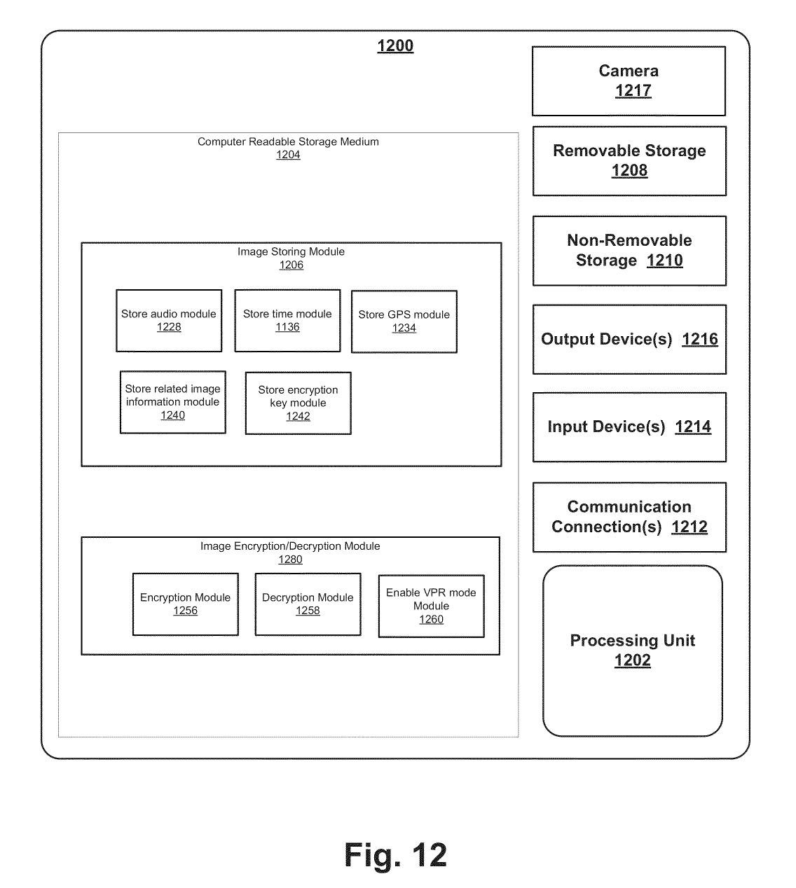

FIG. 12 is a more detailed block diagram of an exemplary computer system and illustrates the various hardware and software components for storing, encrypting and decrypting images in both the camera and the software application in accordance with one embodiment of the present invention.

The camera, in one embodiment, functions substantially similarly to equipment 310, and the software application functions substantially similarly to dedicated software 312.

With reference to FIG. 12, an exemplary system module for implementing embodiments includes a general purpose computing system environment, such as computing system environment 1200. Computing system environment 1200 may include, but is not limited to, laptops, tablet PCs, notebooks, mobile devices, and smartphones. In its most basic configuration, computing system environment 1200 typically includes at least one processing unit 1202 and computer readable storage medium 1204. Depending on the exact configuration and type of computing system environment, computer readable storage medium 1204 may be volatile (such as RAM), non-volatile (such as ROM, flash memory, etc.) or some combination of the two. Portions of computer readable storage medium 1204 when executed facilitate image or video capture.

Additionally, computing system environment 1200 may also have additional features/functionality. For example, computing system environment 1200 may also include additional storage (removable and/or non-removable) including, but not limited to, magnetic or optical disks or tape. Such additional storage is illustrated in FIG. 12 by removable storage 1208 and non-removable storage 1210. Computer storage media includes volatile and nonvolatile, removable and non-removable media implemented in any method or technology for storage of information such as computer readable instructions, data structures, program modules or other data. Computer readable medium 1204, removable storage 1208 and nonremovable storage 1210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1200. Any such computer storage media may be part of computing system environment 1200.

Computing system environment 1200 may also contain communications connection(s) 1212 that allow it to communicate with other devices. Communications connection(s) 1212 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 1212 may allow computing system environment 1200 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1212 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 1200 may also have input device(s) 1214 such as a keyboard, mouse, pen, voice input device, touch input device, remote control, etc. Output device(s) 1216 such as a display, speakers, etc. may also be included. All these devices are well known in the art and are not discussed at length.

Computing system environment 1200 can also have an image storing module 1206. Image storage module 1206 comprises store audio module 1228, which is responsible for accessing and encoding associated audio data into the audio data field 422 of the image. Store time module 1236 is responsible for accessing and encoding associated time data into the time data field 426 of the image. Store GPS module 1234 is responsible for accessing and encoding associated GPS data into the GPS data field 424 of the image. Store related image information module 1240 is responsible for accessing and encoding associated related image information data into the related image data field 428 of the image. Store encryption key module 1242 is responsible for storing encryption flag 430 if the message is encrypted and also encryption key 432 if an encryption keys needs to be transmitted to the recipient of the image.

Computing system environment 1200 may also have an image encryption/decryption module. Encryption module 1056 is programmed to encrypt the image. Decryption module 1058 is configured to decrypt the image. And Enable VPR mode module 1060 is programmed to enable protected memory address mode for the image data so that it cannot be accessed by the user to save or perform a screen capture of the image.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method for sharing digital images, said method comprising:
capturing image data using a digital camera system;
encrypting said image data using an encryption key to produce encrypted image data;
storing metadata associated with said encrypting in at least one field within a file format, wherein said file format defines a structure for storing said encrypted image data, and wherein said at least one field is located within an extensible segment of said file format; and
transmitting said encrypted image data to a recipient.

2. The method of claim 1, wherein said metadata is selected from a group consisting of: an encryption key and said encryption flag.

3. The method of claim 1, wherein said file format is a modification to a file format selected from a group consisting of: JFIF, EXIF, TIFF, PNG, and GIF.

4. The method of claim 1, further comprising:
displaying an image represented by said encrypted image data within a user interface, wherein said user interface comprises an option to display a status of encryption based on said metadata.

5. The method of claim 1, wherein at least one type of metadata is an encryption flag, and wherein said encryption flag is set based on a user specified criterion.

6. The method of claim 1, wherein said encrypting may be performed in accordance with a public key cryptographic procedure, wherein said public key cryptographic procedure may be selected from a group comprising: public key distribution system; shared secrets; digital signature system and public key cryptosystem.

7. The method of claim 1, wherein said encrypting may be performed in accordance with a cryptographic certificate system, wherein said cryptographic certificate system uses a secure certificate system selected from a group consisting of: X.509; RSA; ECC and Diffie-Helman.

8. A method for decoding an image, said method comprising:
receiving image data representing an image, said image data received from a transmitter, wherein said image data comprises a file format with an extensible segment, and wherein said extensible segment comprises at least one field for storing metadata associated with an encryption of said image data; and
determining if said image data is encrypted;
responsive to a determination that said image data is encrypted, decrypting said image data using a decryption key.

9. The method of claim 8, further comprising:
displaying said image using a protected mode, wherein said protected mode protects the memory addresses in which said image data is stored to prevent a user from accessing said memory addresses.

10. The method of claim 9, wherein said protected mode precludes users from accessing a plurality of functions on a receiving device, wherein said functions are selected from a group consisting of: saving image; capturing a screen shot of said image; sharing said image through email; sharing said image through text; sharing said image through a social networking site; and printing said image.

11. The method of claim 8, wherein said metadata is selected from a group consisting of: an encryption key and said encryption flag.

12. The method of claim 8, wherein said file format is a modification to a file format selected from a group consisting of: JFIF, EXIF, TIFF, PNG, and GIF.

13. The method of claim 8, wherein at least one type of metadata is an encryption flag, and wherein said encryption flag is set based on a user specified criterion.

14. An apparatus for sharing digital images, said apparatus comprising:
a display screen configured to display an image;
a memory;
a transmitter module;
a digital camera system;
a processor configured to:
capture image data representing said image using said digital camera system;
encrypt said image data using an encryption key to produce encrypted image data;
store metadata associated with said encrypt operation in at least one field within a file format, wherein said file format defines a structure for storing said encrypted image data, and wherein said at least one field is located within an extensible segment of said file format; and
transmit said encrypted image data to a recipient.

15. The apparatus of claim 14, wherein said metadata is selected from a group consisting of: an encryption key and said encryption flag.

16. The apparatus of claim 14, wherein said file format is a modification to a file format selected from a group consisting of: JFIF, EXIF, TIFF, PNG, and GIF.

17. The apparatus of claim 14, wherein at least one type of metadata is an encryption flag, and wherein said encryption flag is set based on a user specified criterion.

18. The apparatus of claim 14, wherein said encrypting may be performed in accordance with a public key cryptographic procedure, wherein said public key cryptographic procedure may be selected from a group comprising: public key distribution system; shared secrets; digital signature system and public key cryptosystem.

19. The apparatus of claim 14, wherein said encrypting may be performed in accordance with a cryptographic certificate system, wherein said cryptographic certificate system uses a secure certificate system selected from a group consisting of: X.509; RSA; ECC and Diffie-Helman.

20. The apparatus of claim 14, wherein said processor is further configured to display said image within a user interface on said display screen, wherein said user interface comprises an option to display a status of encrypt operation based on said metadata.
